(19) United States
(12) Patent Application Publication
(10) Pub. No.: US 2015/0261948 A1
(43) Pub. Date: Sep. 17, 2015

(54) TWO-FACTOR AUTHENTICATION METHODS AND SYSTEMS

(71) Applicant: COGNITAS TECHNOLOGIES, INC., Sugar Land, TX (US)

(72) Inventors: Dario Marra, New York, NY (US); Jorge Marra, San Rafael, CA (US)

(21) Appl. No.: 14/569,196

(22) Filed: Dec. 12, 2014

Related U.S. Application Data
(60) Provisional application No. 61/951,797, filed on Mar. 12, 2014.

(51) Int. Cl. G06F 21/34; H04L 29/06

(52) U.S. Cl. CPC G06F 21/34; H04L 63/0853

(57) ABSTRACT

A method and system for two-factor authentication used to provide a user access to a target system. After receiving an initial login for a user, a notification is sent to a user device to confirm the transaction. The user may confirm or deny the transaction, alerting the user in real time of any possible fraudulent transactions.

### RELATED APPLICATIONS

This application claims the benefit of U.S. Provisional Patent Application Ser. No. 61/951,797, filed on Mar. 12, 2014, which is hereby incorporated by reference in its entirety.

### FIELD

The present invention relates generally to methods and systems for authenticating access to websites or other documents, over public or private networks.

### BACKGROUND

In certain circumstances, it is desirable to authenticate a user for access to a website or other electronically stored information over a network. Typically, a user can be authenticated using a single password. Single password authentication is vulnerable to common account attacks, such as, brute force guessing attacks, common password attacks, dictionary attacks, pre-knowledge guessing attacks, key logging, phishing and shoulder surfing attacks, all of which lack the security needed in certain circumstances. While increasing the quality of the password or increasing the number of passwords needed for authentication may in some cases reduce the risk of an attack, such authentication methods remain vulnerable.

Other conventional authentication methods require a mobile phone or an authenticating application registered with a website that a user wishes to access. When the user attempts to authenticate with a username and password, the website sends the user a text message with a string that the user must enter in order to be granted access to the website. However, such authentication methods are often time consuming and cumbersome to users, requiring multiple string input steps over long periods of time before access is granted.

Accordingly, there exists a need for authentication methods and systems for providing access to websites and other documents over networks, which reduce the risk of common password vulnerabilities.

### SUMMARY

According to one or more illustrative embodiments, a method provides a secondary authentication of a user performing a transaction. A request is received for a secondary authentication from a target system that has received first authentication data from a user. A user device associated with the user is identified based on the request from the target system. A notification is transmitted to the user device. A confirmation or denial is received from the user device within a timeout interval. And an authorization is submitted to the target system if a confirmation is received from the user device, a denial is submitted to the target system if a denial is received from the user device, or a timeout signal is submitted to the target system if no response is received from the user device within the timeout interval.

According to a further illustrative embodiment, a method provides secondary authentication of a user accessing a target system. An access request is received from a user including first authentication data into a target system. The first authentication data is compared to one or more records to find a match. A user device associated with the user is identified. A notification is transmitted to the user device. A confirmation or denial is received from the user device within a timeout interval. The user is permitted access if a confirmation is received from the user device, denied access if a denial is received from the user device, or a timeout procedure is initiated if no response is received from the user device within the timeout interval.

According to a further illustrative embodiment a system provides secondary authentication of a user performing a transaction. A target system has a target server and a target database containing one or more target user records. The target system is configured to receive an input from a user client and compare the input to the one or more target user records. An authentication system has an authentication server and an authentication database containing one or more authentication user records and a user device associated with each user record. The authentication system is configured to receive data from the target system, compare the data to the one or more authentication user records, submit a notification to a user device, and receive a communication from the user device.

### BRIEF DESCRIPTION OF THE DRAWINGS

The various objects, advantages and novel features of illustrative embodiments of the present invention will be more readily appreciated from the following detailed description when read in conjunction with the appended drawings, in which:

FIG. 1 is a diagram showing an illustrative two factor authentication system;

FIG. 2 is a flow chart showing an illustrative two factor authentication method;

FIG. 3 is a flow chart showing an illustrative provisioning process;

FIG. 4 is a diagram showing an illustrative two factor authentication system utilizing a first and second user device; and

FIG. 5 is a flow chart showing an illustrative two factor authentication method utilizing a first and second user device.

### DETAILED DESCRIPTION OF THE ILLUSTRATIVE EMBODIMENTS

As will be appreciated by one skilled in the art, there are numerous ways of carrying out the examples, improvements, and arrangements of a authentication system and method. Although reference will be made to the illustrative embodiments depicted in the drawings and the following descriptions, the embodiments disclosed herein are not meant to be exhaustive of the various alternative designs and embodiments that are encompassed by the invention, and those skilled in the art will readily appreciate that various modifications may be made, and various combinations can be made, without departing from the invention.

According to various exemplary embodiments, a two-factor authentication process is used to provide a user with access to a target system, for example an electronic system or information. The authentication process can be used to provide secure access to a client, portal, website, electronic documents, or other electronic systems and files. In certain embodiments, the authentication process utilizes first authentication data and a confirmation communication to a user, for example through an electronic device associated with the user.

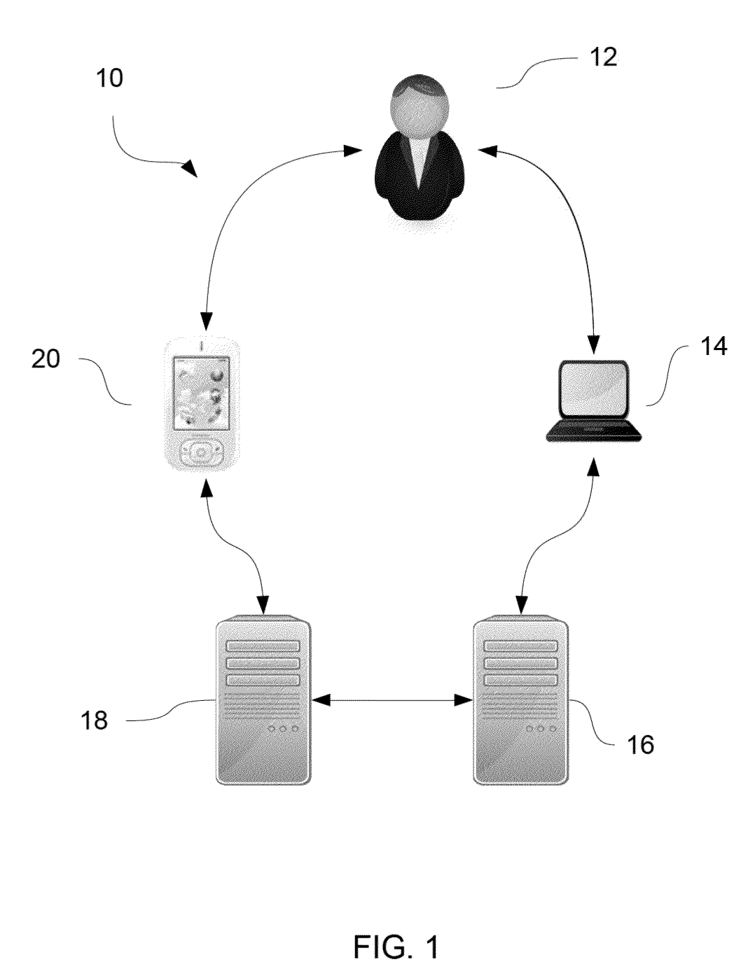

FIG. 1 depicts an illustrative embodiment of a system 10 utilizing a two-factor authentication process such as the PocketID™ system and process provided by Cognitas Technologies Inc. The process includes a user 12 accessing a client 14 in an attempt to obtain access to information or a service provided by a target system 16. For example the client 14 may be a computer device such as a desktop, laptop, tablet, smartphone etc. accessing a bank website or portal that provides bank information and enables bank transactions hosted on the target system 16. The target system 16 can also be a transactional system where a user 12 performs a purchase or other transaction, for example an online purchase with a credit card or an ATM withdrawal. The computer device used to implement the transaction may be the same as the user device 20 used to confirm the transaction. The client 14 communicates with a communication unit of the target system 16 over a network, for example a telephone network, local area network (LAN), wide area network (WAN), Wi-Fi, or through the Internet. In certain embodiments the client 14 may communicate with the target system 16 through a short-range communication for example, near field communication, infrared communication, or radio communication (such as Bluetooth) or other communication link. In other embodiments, the client 14 and the target system 16 may be part of an integrated system or unit, for example an ATM machine or other dedicated system.

In an illustrative embodiment, the target system 16 includes a target server that receives first authentication data from the user. In an exemplary embodiment, the first authentication data includes a username and a password associated with a user 12. The user 12 inputs the username and password, for example by typing, and it is transmitted to the target server. In alternative embodiments, other authentication methods can be used, including, but not limited to, multiple passwords, electronic card or ID scan data, and biometrics data. The target system 16 includes or is in communication with a target database containing information on one or more users. The target system 16 compares the user's first authentication data with the information stored in the target database, for example one or more existing records, to find matching information. If matching information is found the target system 16 accepts the first authentication data. If no matching information is found, an error message may be presented to the user 12.

If the first authentication data is accepted by the target system 16, the target system 16 then determines or recognizes if a second authentication step is required. In an illustrative embodiment, a web browser extension, plug-in, or other web application recognizes a webpage login and instigates the second authentication step. In other illustrative embodiments, the target system 16 determines if the user 12 or the target institution has required a second authentication step. If a second authentication step is required, information identifying the user 12 is then passed to a secondary unit, for example an authentication system 18, to perform a second authentication step.

While awaiting the second authentication step, the user 12 may be presented with a waiting icon, such as a spinner or hourglass, or a notification screen informing them that the second authentication step is in progress. The target system 16 communicates with a communication unit of the authentication system 18 over a network, a short-range communication, a direct communication, or other communication link. In an illustrative embodiment, communication between the target system 16 and the authentication system 18 utilizes a library, for example a shared library or dynamic link library. During installation or loading of the library, no changes are required to the target system 16 or applications, except for configuration settings to properly load the library. A web browser extension, plug-in, or web app may be associated with the portal used to access the target system 16 and the authentication system 18 to facilitate performing the second authentication step as well as the communication between the target system 16 and the authentication system 18.

The authentication system 18 receives information from the target system 16 identifying the user 12 that can include, but is not limited to, a user ID, or a portion of the first authentication data. In an exemplary embodiment, the authentication system 18 includes an authentication server and an authentication database containing information on one or more users. In various embodiments, the information stored in the authentication database includes user account information and one or more user devices 20 associated with an account. The authentication system 18 compares the data received from the target system 16 with the information stored in the authentication database to find matching information. If no matching information is found, an error message may be sent to the target server, the user, or both. If matching information is found the user account and an associated user device is identified.

Once an associated user device is identified, the authentication system 18 sends a notification to the user device 20. The notification communication may be sent over a network or through a short-range communication. The notification informs the user 12 of the attempt to access the target system 16. The notification may include information related to the target system 16, such as the type of transaction that has been initiated. For example, if a website is being accessed, the notification may communicate to the user device 20 the company and/or account that is being accessed. In another example, if bank transaction is attempted, the notification may communicate the type of transaction or the originating account. The notification may be way of an Email, SMS, pop-up, push notification, or other forms of notification depending on the associated user device 20. In an embodiment utilizing a mobile phone, a push notification is sent to the user and may be capable of displaying on a user's lock screen, home screen, or a screen currently in use by the user.

In an exemplary embodiment, the user device 20 is an electronic device that a user typically possesses or has regular access. Various user devices 20, including network-enabled devices and other associated devices can be employed. A user device 20 can include any computer or mobile device, including, but not limited to, a personal computer, a laptop, a mobile phone, a tablet computer, wearable electronic device, or any telecommunication device with computing and networking ability, the ability to connect or communicate with a network-enabled device, or the ability to send and receive phone calls or text messages. The user device 20 includes various hardware components, including, but not limited to, a processing unit, memory, various buttons, a touchscreen, a keyboard, a camera or scanning device, and communication components such as Wi-Fi, Bluetooth, mobile data, or other communication units.

Computer related software, such as a program or application is installed on the user device 20 and executed by the various hardware components that make up the device. The software application may be computer based, mobile based or web based. Various operating systems may be used to run the software application including Windows based operating systems, Apple based operating systems, mobile operating systems, such as iOS and Android, and other software platforms.

The user device 20 can include an adaptable user interface such as, but not limited to a keyboard, a keypad, a touchpad, a pointing device, or a touchscreen. In an exemplary embodiment, the user device 20 is a mobile phone, such as a, smartphone owned by the user. In another exemplary embodiment, the user device 20 is a wearable device, for example a smart watch, smart glasses, or wearable fitness tracker. The wearable device may be enabled for network connectivity or it may connect to a network enabled device, such as a smartphone, through a short-range communication method, such as Bluetooth or Wi-Fi. The system thereby leverages a programmable, network-connected device that the user is likely to own for various purposes other than authentication, in order to increase security and the user's return on investment.

After receiving the notification, the user 12 confirms or denies the transaction through an input to the user device 20. In an exemplary embodiment, a mobile phone includes a software component or application that is associated with the authentication process. The user 12 receives the notification through the mobile phone and provides an input, for example by pressing a key or a button presented on the screen, to confirm or deny the transaction. In an exemplary embodiment, the user may be prompted with a message indicating the type of transaction and provide with simple “Yes” and “No” buttons. The same or similar process may be utilized on a tablet, wearable device, or other computer device. Certain devices may only have a touchscreen and the transaction may be confirmed or denied by a gesture or swiping motion. In embodiments where the user device 20 has a limited input, for example a single button, the number of inputs, for example two presses for Yes one for No, or the time interval of the input, for example holding down a button for a certain length of time, can indicate the response. In various exemplary embodiments, a security feature may be associated with confirming a transaction. For example, a user 12 may need to enter a pin, provide a certain input in a certain sequence, or input biometric data at the application level or the user device level to send the confirmation. Such security features can be similar, but not limited, to a phones lock/unlock security features. In an illustrative embodiment, the user 12 may be provided with the notification on the lock screen or home screen and then must log into the phone through an established procedure to access the application and send the response. After confirming or denying the transaction, the user's input is communicated to the authentication system 18. In various alternative embodiments, the user device 20 can automatically provide an answer under certain circumstance, examples of which are discussed in greater detail below.

If the user 12 confirms the transaction, the authentication system 18 communicates the confirmation to the target system 16 which allows the transaction to be completed. If the user 12 denies the transaction, the authentication system 18 communicates the denial to the target system 16 which cancels the transaction or otherwise prevents it from being completed. The user 12 is alerted in real time about a possible fraudulent transaction and notification can be sent to the target institution. If a transaction is denied, additional security steps may be taken, such as, contacting the user 12, disabling a user account, or taking other appropriate steps to deal with a failed authentication. Steps taken after a denial may be chosen or established by the user 12, the target institution, or a combination of both. In an exemplary embodiment, a log is created of every authentication attempt that may be reviewed for security purposes.

If the transaction is neither confirmed nor denied, the authentication system 18 informs the target system 16 of timeout interval. After receiving notice of a timeout, the target system 16 can cancel the transaction or request additional authentication information from the user 12. In an illustrative embodiment, if the authentication system 18 is unable to reach the user device 20, the authentication server sends a timeout signal to the target system 16 and/or other data indicative of a failed communication with the user device 20. The authentication system 18 or the target system 16 can then provide the user 20 with an option to perform one or more additional authentication procedures. For example, the target system 16 can ask for addition identifying information such as security question information (mother's maiden name, social security number, etc.). In an illustrative embodiment, the authentication system 18 submits an authentication code or string to the target system 16. The target system 16 can then prompt the user 12 to enter the authentication code. This authentication code can be a one-time code or any type of authentication string or code, for example a 16-character string. The code may be generated by or stored in the user device 20 similar to the PocketToken™ application by Cognitas Technologies Inc. For example, an application associated with the user device 20 generates a one-time code for use if the user device 20 is unable to connect to a network or through a short-range communication. The user 12 can then access this code to submit to the target system 16. The target system 16 compares the code entered by the user 12 with the code received from the authentication system 18. If the codes match, the transaction is completed. If the codes do not match, the transaction is rejected. According to an exemplary embodiment, after a one-time code is used, the user device 20 may need to update the code or receive a different code from the authentication system 18. In certain embodiments, the authentication system 18 and user device 20 are synced so that they will generate matching one-time codes, either for a set number of codes or unlimited. The authentication system 18 and user device 20 can also update periodically, for example every time connectivity can be established, a set time period (once a day, week, month, etc.) or randomly to make it harder for a pattern to be established an increase security.

In an alternative embodiment, the system described above can be used for commercial transaction verification where the access request is to provide access for payment of goods or services. The target system 16 is one for performing a transaction, for example an online purchase. The purchase may be made using any type of payment method, including credit card, currency, e-currency, or other type of payment transfer. During transaction verification, the first authentication data can be a user name and password, credit card information, or other type of currency transfer information. If secondary authentication is required, the authentication system 18 can perform the second authentication step as discussed above. The user 12 must provide confirmation, for example with the user device 20 to complete the transaction.

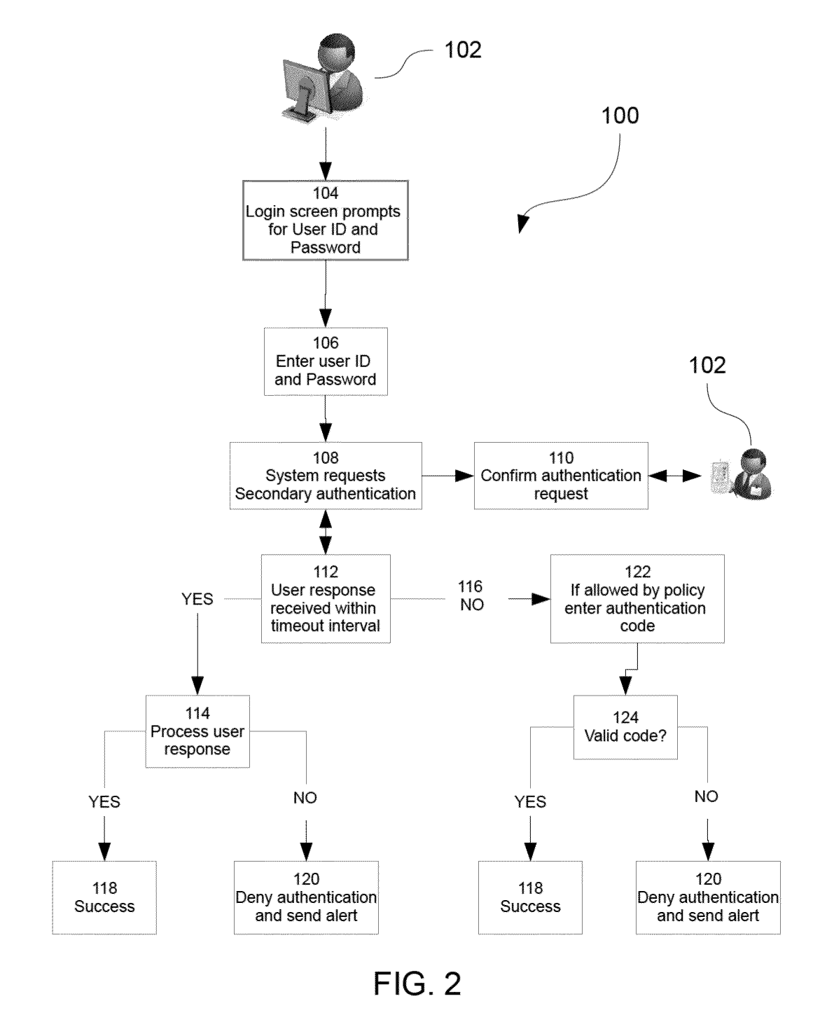

FIG. 2 depicts an illustrative embodiment of an authentication method 100 for a user registered with an authentication system providing a two-factor authentication process such as the PocketID™ system and process provided by Cognitas Technologies Inc. The two-factor authentication process may be required by a user 102 or by a target institution. The method 100 may be implemented using the system discussed above or by utilizing other components. A user 102 accesses the login page of a website associated with a target system to perform a transaction. The user 102 is prompted 104 for first authentication data such as username and password. The user 102 enters 106 the first authentication data and submits it to the target system. The target system compares the user's first authentication data with stored information, for example in a target server database, to find matching information. If matching information is found the target system accepts the first authentication data. If no matching information is found, an error message may be presented to the user 102.

If the first authentication data is accepted by the target system, the target system then determines if a second authentication step is required 108. If the user or the target institution has required a second authentication step, the target system submits information identifying the user to a secondary unit, for example an authentication system, to perform a second authentication step 108. While awaiting the second authentication step 108, the user 102 may be presented with a waiting icon, such as a spinner or hourglass, or a notification screen informing them that the second authentication step 108 is in progress. The authentication system compares the data received from the target system with stored information, for example information stored in a database, to recognize a user account and a user device associated with the account. If no matching information is found, an error message may be sent to the target system, the user, or both. If matching information is found the user account and an associated user device is identified.

Once an associated user device is identified, the authentication system sends a notification to the user device 110. The notification 110 alerts the user of the pending transaction. The notification 110 may include information related to the target server, such as the type of transaction that has been initiated. For example, if a website is being accessed, the notification 110 may communicate to the user device the company and/or account that is being accessed. After alerting the user, the authentication system waits a set amount of time for a response 112. After receiving the notification 110, the user confirms or denies the transaction through an input to the user device or no response is transmitted. If the user responds, the user's input is communicated to the authentication system 114. If no response is submitted within the established timeframe, the authentication server times out 116.

If the user 102 confirms the transaction, the authentication server communicates the confirmation to the target server which allows the transaction to be completed 118. If the user 102 denies the transaction, the authentication server communicates the denial to the target server which cancels the transaction or otherwise prevents it from being completed 120. If a transaction is denied, additional security steps may be taken, such as, contacting the user, or disabling a user account, or taking other appropriate steps to deal with a failed authentication. If the transaction is neither confirmed nor denied, the authentication server informs the target server of a timeout 116.

In an illustrative embodiment where the user denies the transaction attempt 120, increased security is provided, in real time, in the event that an individual successfully entered the user's credentials at the login screen, without the user's permission. A denial not only immediately informs the user 102, but can also trigger a variety of defense and alert actions, as desired by the administrator of the target system or the user 102. For example, an administrator of the target system can be alerted of a potential intrusion and steps can be taken to determine the type and location of the intrusion. The real-time quality of such an alert provides a strong security feature.

In certain circumstances, the user 102 may not respond for a number of reasons, such as, but not limited to, not being near the user device, not having access and control to the user device, or not being able to send or receive the required communication with the user enabled device. After receiving notice of a timeout, the target system can cancel the transaction or request additional authentication information from a user. In an illustrative embodiment, if the authentication system is unable to reach the user device, the authentication server sends a timeout signal 116 to the target system and/or other data indicative of a failed communication with the user device. The authentication system or the target system can then provide the user with an option to perform one or more additional authentication procedures. For example, the target system can ask for addition identifying information such as security question information (mother's maiden name, social security number, etc.).

In an illustrative embodiment, the authentication server may also receive an authentication code or string to permit access to the target system. The target system can prompt the user 102 to enter an authentication code 122. This authentication code can be a one-time code or any type of authentication string or code. The code may be generated by or stored in the user device and provided to the user upon request. For example, an application associated with the user device may store a one-time code for use if the device is unable to connect to a network or through a short-range communication. The user 102 can then access and input, or otherwise provide, the code to the target server. The code entered by the user 102 is then compared, for example by the authentication server, with the stored code. If the codes match, the transaction is completed 118. If the codes do not match, the transaction is rejected 120. A rejected code can trigger an alert or other defensive action, for example locking the account. In an alternative embodiment, the authentication server may transmit the code to the target system and the target system receives the code from the user and compares the user input code to the code received from the authentication server.

In an alternative embodiment, the method described above can be used for commercial transaction verification where the access request is to provide access for payment of goods or services. The user 102 initiates a transaction and enters 106 first authentication data. The first authentication data can be a user name and password, credit card information, or other type of currency transfer information. If a second authentication step 108 is required, the authentication system can perform the second authentication step as discussed above. The user 102 can confirm or deny the transaction, or face a timeout sequence, as discussed above.

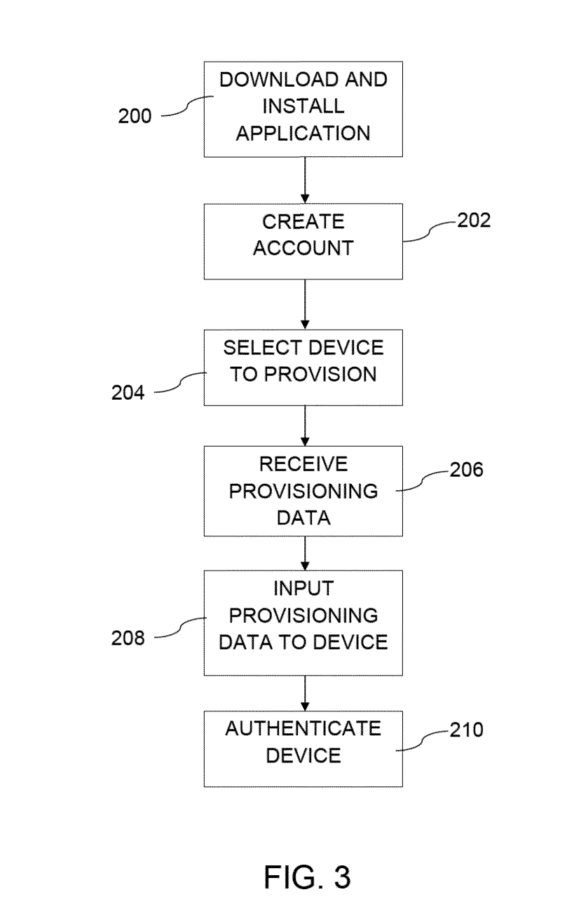

In accordance with an illustrative embodiment, the user device is provisioned with the authentication server. FIG. 3 depicts a method of provisioning the user device to increases the security strength of the authentication process. In setting up an account, a user enters information, for example, a username, password, email address, home address, phone number, etc. After the account information is entered, the user selects one or more user devices to provision 204. In certain embodiments, only a single device is provisioned to increase security, while in other embodiments a user may provision more than one device for convenience. After a device is selected, the provisioning process authenticates the device.

Provisioning authentication involves receiving provisioning data 206 through one or more of email, SMS, photographic, barcode, or Quick Response (QR) code provisioning selected by a user. For example, a user that has selected a mobile phone as the user device receives a QR code that is scanned or captured in a photograph and importing the resulting data into the user device. Provisioning by email or text message, for example, requires the user to manually copy and enter information into the user device. Provisioning can be done remotely or in person, for example, at a bank branch. In an exemplary embodiment, the provisioning information is generated by the authentication system and provided to the user. The user enters the provisioning information into the user device 208 and the user device authenticates the provisioning information with the authentication server 210.

Once the server receives the proper provisioning information, the user device is stored, for example in an authentication database, and associated with a specific user along with an additional authentication factor, such as, but not limited to a PIN or password that is provided during provisioning. Alternatively, this additional authentication factor can be integrated with existing authentication repositories to leverage existing user passwords already in use. In an illustrative embodiment, any and all steps of the authentication or provisioning method are logged on a the user device and/or on the authentication server to be used for troubleshooting or for auditing purposes.

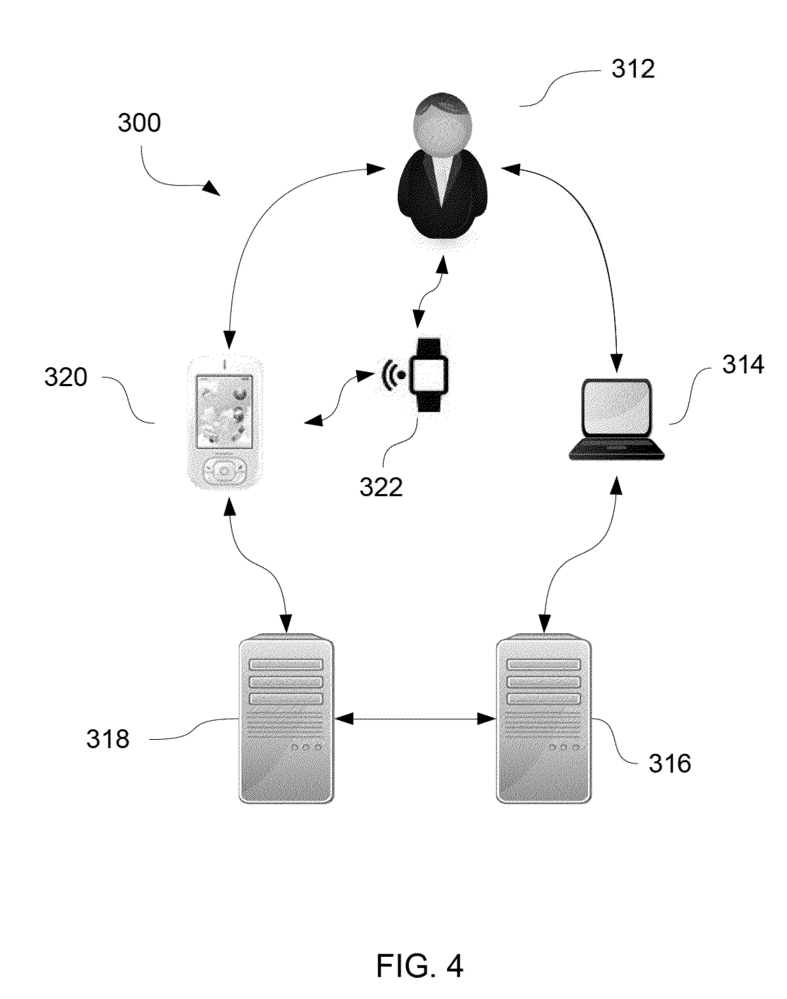

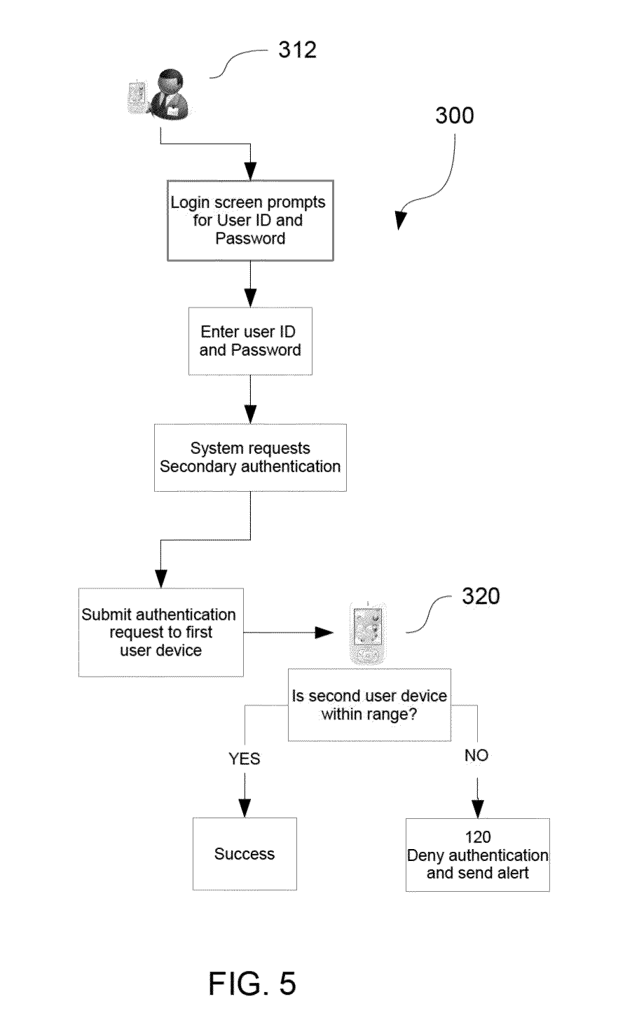

FIGS. 4 and 5 depict an illustrative embodiment of an authentication system and method 300 that includes a user 312 accessing a client 314 in an attempt to obtain access to information or a service provided by a target system 316. If a second authentication step is required, information identifying the user 312 is then passed to an authentication system 318, to perform a second authentication step. The authentication system 318 compares the data received from the target system 316 with the information stored in the authentication database to find matching information, for example an associated first user device 320. The authentication system 318 sends a notification to the first user device 320. In the illustrative embodiment, the first user device 320 is paired with a second user device 322. In an exemplary embodiment, the first user device 320 is a smartphone, tablet, laptop, or other portable computing device and the second user device 322 is a wearable device or a token device. The first and second user devices 320, 322 may take any form of electronic device, either through the use of a dedicated device or a device having a specific application or other software compatible with the use of the system and method described herein. The first and second user devices 320, 322 may be paired through a short-range communication for example, near field communication, infrared communication, or radio communication (such as Bluetooth) or other communication link.

When the first user device 320 receives a notification of an authentication request from the authentication sever 318, a check is made to determine if the second user device 322 is within range of the first user device 320. The range may be limited by the user or application, or the range may be the standard range of the communication link. For example, when using Bluetooth communication a range may specified by the application. In an illustrative embodiment, the range is between 0-10 feet, for example within 3, 4, 5, or 6 feet. If the first and second user devices 320, 322 are within range of each other, then confirmation of the authentication request is automatically granted and passed to the authentication server. Use of a second user device 322 permits a greater ease of use and also increases the security of the system and method. In an illustrative embodiment, the user of the second user device 322 may be mandated when the target system 316 is being accessed with the first user device 320. This prevents a security breach where a first user device 320 is stolen.

In an alternative embodiment, the system and method described above utilizing a second user device 322 can be used for commercial transaction verification, for example an online purchase as discussed herein.

In accordance with the various exemplary embodiments discussed herein, the authentication systems and methods may also be configured to provide information to a user. The information may include notifications, alerts, or advertisements provided to the user. The information may originate with the target system or organization, or with a third party vendor. The information may be presented to the user at any point during the process, for example when the notification or confirmation screen is provided to the user during secondary authentication. In an exemplary embodiment, when secondary authentication is required during a login, for example to an online bank account, the bank can provide an advertisement to a user when the user is prompted to confirm the account login. In another exemplary embodiment, when secondary authentication is required during a commercial transaction, the commercial institution can provide an advertisement to a user when the user is prompted to confirm the commercial transaction. The information may be specifically targeted or tailored for the user based on transaction history, location, or other personal data.

The components of the illustrative devices, systems and methods employed in accordance with the various embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution in accordance with, or to control the operation of, data processing apparatus such as a programmable processor, a computer, or multiple computers. Examples of the computer-readable recording medium include, but are not limited to, read-only memory (ROM), random-access memory (RAM), CD-ROMs, magnetic tapes, floppy disks, optical data storage devices. It is envisioned that aspects can be embodied as carrier waves (such as data transmission through the Internet via wired or wireless transmission paths).

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains. Method steps associated with the illustrative embodiments of the present invention can be performed by one or more programmable processors executing a computer program, code or instructions to perform functions (e.g., by operating on input data and/or generating an output). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention. Method steps can also be performed in accordance with, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented in accordance with, or incorporated in special purpose logic circuitry.

Although only a few illustrative embodiments have been described in detail above, those skilled in the art will readily appreciate that many modifications are possible in the illustrative embodiments, and various combinations of the illustrative embodiments are possible, without materially departing from the novel teachings and advantages of this invention. Accordingly, all such modifications are intended to be included within the scope of this invention.

What is claimed:

1. A method of providing secondary authentication of a user performing a transaction comprising:
receiving a request for a secondary authentication from a target system that has received first authentication data;
identifying a user device associated with the user based on the request from the target system;
transmitting a notification to the user device;
receiving a confirmation or denial from the user device within a timeout interval; and
submitting an authorization to the target system if a confirmation is received from the user device, submitting a denial to the target system if a denial is received from the user device, or submitting a timeout signal to the target system if neither a confirmation or a denail is received from the user device within the timeout interval.

2. The method of claim 1, further comprising determining if secondary authentication is required for a transaction initiated by a user.

3. The method of claim 1, wherein identifying a user device associated with a user comprises comparing data received from the target system with one or more existing records to locate matching information.

4. The method of claim 1, further comprising prompting the user for a authentication code if a timeout signal is received.

5. The method of claim 1, wherein transmitting a notification to the user device comprises a network communication.

6. The method of claim 1, wherein transmitting a notification to the user device comprises a short-range communication.

7. The method of claim 1, wherein the notification is selected from the group consisting of Email, SMS, pop-up, and push notifications.

8. The method of claim 1, further comprising submitting a provisioning request to a user and establish a record of a user and a provisioned user device.

9. The method of claim 1, wherein the user device is a smartphone.

10. The method of claim 9, wherein the user device includes a software application for receiving the notification and sending the confirmation.

11. The method of claim 1, wherein the user device is a wearable device.

12. The method of claim 1, wherein the user device is paired with a second user device and the confirmation is automatically transmitted by the user device if the second user device is within range of the user device.

13. The method of claim 1, wherein the notification includes an advertisement from the target system.

14. A method of providing secondary authentication of a user accessing a target system comprising:
receiving an access request including first authentication data into a target system;
comparing the first authentication data to one or more records to find a match;
identifying a user device associated with the user;
transmitting a notification to the user device;
receiving a confirmation or denial from the user device within a timeout interval; and
permitting access to the user if a confirmation is received from the user device, denying access to the user if a denial is received from the user device, or initiating a timeout procedure if no response is received from the user device within the timeout interval.

15. The method of claim 14, further comprising submitting a request for secondary authentication from the target system to an authentication system and wherein identifying the user device associated with the user, transmitting the notification to the user device and receiving a confirmation or denial from the user device is performed by the authentication system.

16. The method of claim 14, wherein the user performing the transaction accesses the target system by entering the first authentication data into a client that communicates with the target system and the first authentication data includes a username and password.

17. The method of claim 14, wherein the timeout procedure includes the user device transmitting a one-time code to the user for input to the target system.

18. The method of claim 14, wherein the access request to is to permit access to a user account.

19. The method of claim 14, wherein the access request is to provide access for payment of goods or services.

20. A system providing secondary authentication of a user performing a transaction comprising:
a target system having a target server and a target database containing one or more target user records, the target system configured to receive an input from a user client and compare the input to the one or more target user records; and
an authentication system having an authentication server and an authentication database containing one or more authentication user records and a user device associated with each user record, the authentication system configured to receive data from the target system, compare the data to the one or more authentication user records, submit a notification to a user device, and receive a communication from the user device.

21. The system of claim 20, wherein the authentication system is configured to submit an authorization to the target system if a confirmation is received from the user device, submit a denial to the target system if a denial is received from the user device, or submitting a timeout signal to the target system if no response is received from the user device within a timeout interval.

22. The system of claim 21, wherein the authentication server is configured to authenticate a one-time code if no response is received from the user device within a timeout interval.

23. The system of claim 22, further comprising a first user in communication with the authentication system and a second user device paired to the first user device, the first user device configured to send a confirmation to the authentication system when the second user device is within range of the first user device.
